(19) United States
(12) Patent Application Publication
(10) Pub. No.: US 2007/0220586 A1
(43) Pub. Date: Sep. 20, 2007

(54) Computing resource assignment method and apparatus using genetic algorithms

(76) Inventors: Norman Salazar, Hermosillo (MX); Cipriano A. Santos, Modesto, CA (US); Xiaoyun Zhu, San Jose, CA (US); James C. Pruyne, Naperville, IL (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/366,853

(22) Filed: Mar. 1, 2006

(51) Int. Cl. H04L 9/00

(52) U.S. Cl. 726/1

(57) ABSTRACT

A computer-based solver provides a method of assigning computing resources in a data center to meet computing resource requirements of an application. The solver initially creates a list of application components wherein each application component represents a largest possible combination of shared resource requirements from the application. Next, the solver identifies a set of eligible resource servers with each resource server capable of fulfilling the resource requirements for each application component in the list of application components. Typically, the resource requirements of either the shared or discrete are met by a resource server with sufficient capacity. If there is at least one feasible solution, the solver then matches an optimal combination of resource servers to each application component in the list of application components using a genetic algorithm (GA). The GA rapidly evaluates the solutions to find an optimal solution that tends to have lesser overall costs compared to other solutions identified.

### BACKGROUND OF THE INVENTION

A data center design and implementation generally reflects the needs of a company or enterprise at a particular point in time. The computing capability, network capacity and communication links implemented in data centers are generally built around running certain applications, accessing certain databases and using other resources. Generally, the resources needed to run these various applications in an enterprise dictate many of the computer hardware and system capabilities implemented in the data center.

Unfortunately, the companies running these applications and systems often have changing needs as local or international marketplaces experience rapid and unpredictable changes in. In some cases, these needs may also change with certain technological advances that improve margins and profit through lower costs in manufacturing and data processing. Data centers in these companies must also change to accommodate the changing needs of these companies. If at all possible, these companies would rather reuse and reconfigure existing hardware and software to reduce capital costs associated with purchasing new equipment and redesigning the data center infrastructure.

The complexity of reusing equipment in a large enterprise can be daunting as the resources available may not be well suited to the new applications. For example, hardware may not be optimally placed and/or configured given a particular application resource requirement. In some cases, it is possible that one deployment of an application on a system may have sufficient resources to fulfill computing requirements but have insufficient network capacity to deliver the computational results across networks and other communication paths. Other deployments may have sufficient communication bandwidth to deliver the results but lack adequate computing resources to satisfy the computational requirements in an acceptable time frame. It is also possible that certain solutions may have adequate resources for a portion of an application but insufficient remaining computing and communication capabilities needed for the complete application deployment.

### BRIEF DESCRIPTION OF THE DRAWINGS

FIG. 1 depicts a flowchart diagram of the operations for analyzing a set of resource servers in a computing and network enterprise in accordance with one implementation of the present invention;

FIG. 2A is a schematic diagram of one or more application components and the communication requirements between the application components for a given application;

FIG. 2B depicts an exemplary physical network of resource servers communicating in a hierarchical manner;

FIG. 2C depicts an alternate physical network of resource servers coupled together over a rack switch rather than in a hierarchical manner;

FIG. 3 depicts an architecture used by one implementation of the present invention to assign resource servers to the requirements of one or more application components;

FIG. 4A provides a flowchart for the operations of assigning resource servers to one or more application components in accordance with one implementation of the present invention;

FIG. 4B is a flowchart diagram of the operations associated with creating a super-application component from individual discrete application components and requirements from an application in accordance with one implementation of the present invention;

FIG. 4C is a flowchart of operations for a genetic algorithm designed in accordance with one implementation of the present invention to select an optimal assignment of resource servers to the application components and their requirements;

FIG. 4D is a flowchart of the operations for tournament selection of resource server solutions from a population in accordance with one implementation of the present invention;

FIG. 4E is a flowchart of the operation used to cross-over resource server solutions and mutate offspring in accordance with one implementation of the present invention;

FIG. 4F represents a schematic of increasing the efficiency associated with mutating each gene in a genetic algorithm given a number of resource server solutions according to one implementation of the present invention;

FIG. 4G provides one calculation for determining the number of spins of the roulette wheel for mutating resource server solutions in accordance with one implementation of the present invention; and

FIG. 5 is a schematic diagram of an application component placement system and modules used in accordance with one implementation of the present invention.

Like reference numbers and designations in the various drawings indicate like elements.

### SUMMARY OF THE INVENTION

One aspect of the present invention describes a method of assigning resource servers in a data center to meet computing resource requirements of an application. A solver initially creates a list of application components wherein each application component represents a largest possible combination of shared resource requirements from the application. Next, the solver identifies a set of eligible resource servers with each resource server capable of fulfilling the resource requirements for each application component in the list of application components. Typically, the resource requirements, either shared or discrete, are met by a resource server with sufficient capacity. If there is at least one feasible solution, the solver then matches an optimal combination of resource servers to each application component in the list of application component using a genetic algorithm (GA). The GA rapidly evaluates the solutions to find an optimal solution that tends to have lower overall costs compared to other solutions identified.

### DETAILED DESCRIPTION

Aspects of the present invention are advantageous in at least one or more of the following ways. In general, implementations of the present invention can be used on an arbitrary tree topology of computing and communication resources. Combinations of computing resources, network resources or other resources are referred to as resource servers as they may include any resource that can be allocated or assigned. Application resource requirements are represented as application components that can be fitted to an optimal combination of resource servers using genetic algorithm (GA) selection techniques. In many cases, the existing resource servers in an enterprise can be used and reused for different applications without significant reconfiguration or redesign.

Feasibility of deploying applications over existing resource servers is also evaluated. Before assigning the resource servers to an application component requirement, an overall feasibility assessment is made to ensure at least one complete solution is possible. The GA explores an increasingly larger number of randomly generated solutions to either rapidly converge on a solution or indicate that there is likely no feasible solution. Changes can be made to the resource servers in the enterprise or the application requirements and a feasibility determination can be run again until at least one solution is finally found.

Once feasibility is determined, implementations of the present invention operate to then select an optimal combination of resource servers to fulfill the application's resource requirements. If many possible solutions exist, the GA approach pits one resource server solution against another until one of several resource server solutions approximates an optimal if not best solution. In particular, a tournament GA approach used by implementations of the present invention helps for a more rapid convergence on a solution compared with linear or brute force solutions that may need to evaluate a much larger number of possibilities. Further details on using tournament selection in a GA based solver are described in further details later herein.

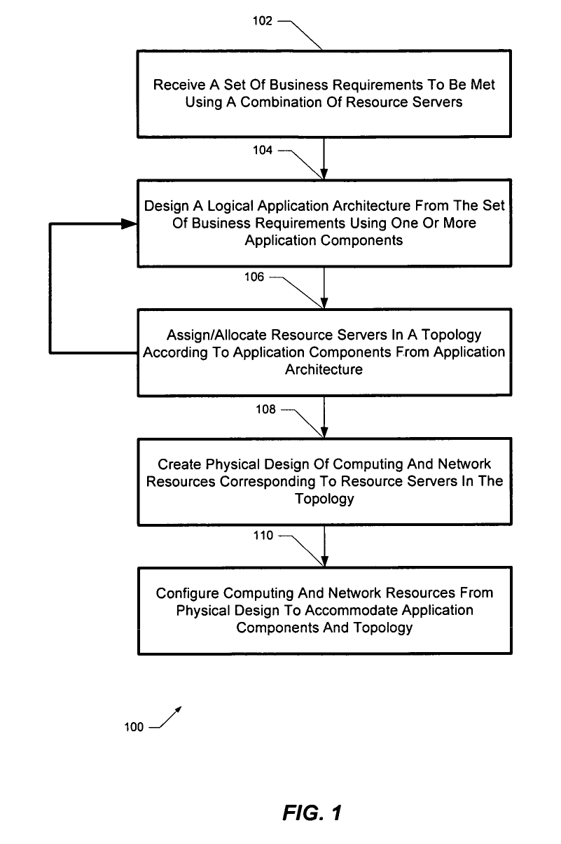

FIG. 1 depicts a flowchart diagram of the operations for analyzing a set of resource servers in a computing and network enterprise in accordance with one implementation of the present invention. Initially, an enterprise specifies a set of business requirements to be met using a combination of resource servers (102). The resource servers may include various computing, communication, or other resources. For example, a long-lived e-commerce application may require supporting a number of concurrent users performing a certain number of transactions per second during peak operation of the e-commerce application. Alternatively, a short-term or one-time computational requirement may specify using a certain amount of computing resources for analyzing business data and then distributing the results securely over an enterprise intranet or the Internet with certain minimum communication performance requirements.

A designer uses these business requirements to develop a logical application architecture that uses a set of one or more application components (104). Each application component in the set has specific capacitive and non-capacitive requirements needed to perform a task or set of tasks. For example, capacitive requirements may include a certain amount of computational power while non-capacitive requirements may relate to an operating system type (i.e., Windows, Linux, Mac) or processor type (i.e., AMD, Intel, Sparc). These requirements can be specified as minimums, maximums or bracketed to include a range of performance values depending on the particular application design.

Next, implementations of the present invention assign or allocate resource servers in a topology according to application components derived from the application architecture (106). In some cases, the physical topology of these resource servers have bee designed in conjunction with the requirements specified by the application components. This sometimes provides more flexibility since the physical topology can be changed as needed (106) in an iterative manner before actual implementation. In the first instance, this aforementioned process may be referred to as an allocation of physical resources since the resource servers are allocated as needed to the requirements of each application component.

In contrast, an assignment operation describes reusing an existing topology of server resources. Instead of allocating the server resources, they are fitted to the application component requirements of the application in an optimal manner. This latter approach conceptually may be referred to as an assignment problem since the resource server topology is set and the resources are instead being assigned to the application components with little or no changes in their physical arrangement.

To deal with the complexity of solving this problem, implementations of the present invention utilize GA techniques to converge upon an optimal solution. The optimal solution represents one of potentially several solutions based upon the constraints of the resource servers and the requirements of the application components associated with the application. While it is possible that the optimal solution may in fact be the best solution under the circumstances, this is generally not a requirement provided to the solver for it to operate.

Using the resulting optimal solution, the solver creates a physical design of computing and network resources corresponding to resource servers in the topology (108). As previously described, this operation typically assigns one or more resource servers to certain application components depending on the application and the resource requirements. For example, multiple application components sharing the same database may be placed on single resource server that services the database. Further details on application components and shared resources assigned between application components are described later herein.

As a final step in the deployment, implementations of the present invention configure computing and network resources from physical design to accommodate application components and topology (110). This operation may involve getting images of application components from centralized storage and installing them on assigned computers, configuring network switches to enable traffic between communicating application components, and setting up database tables with appropriate content.

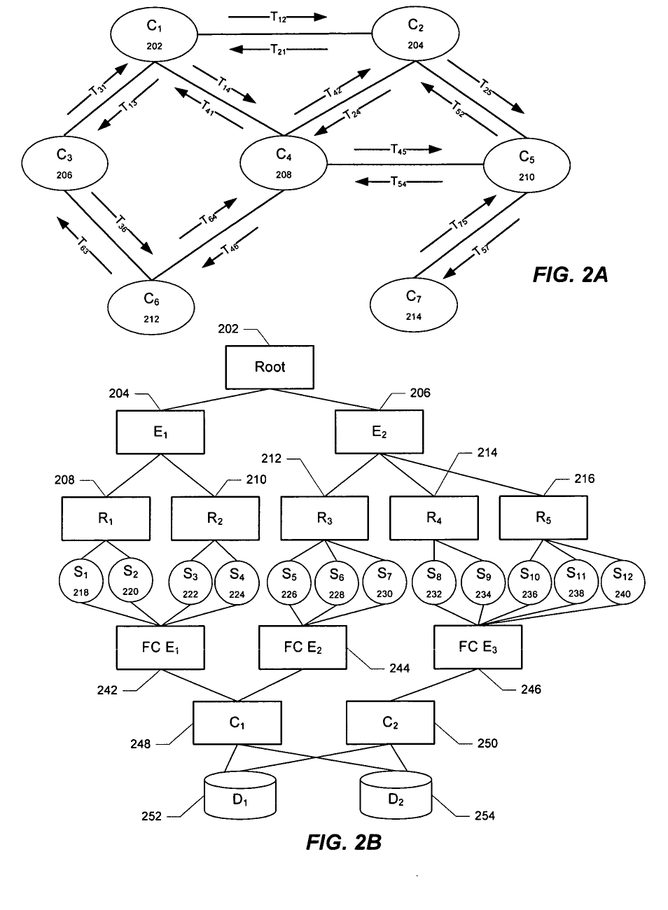

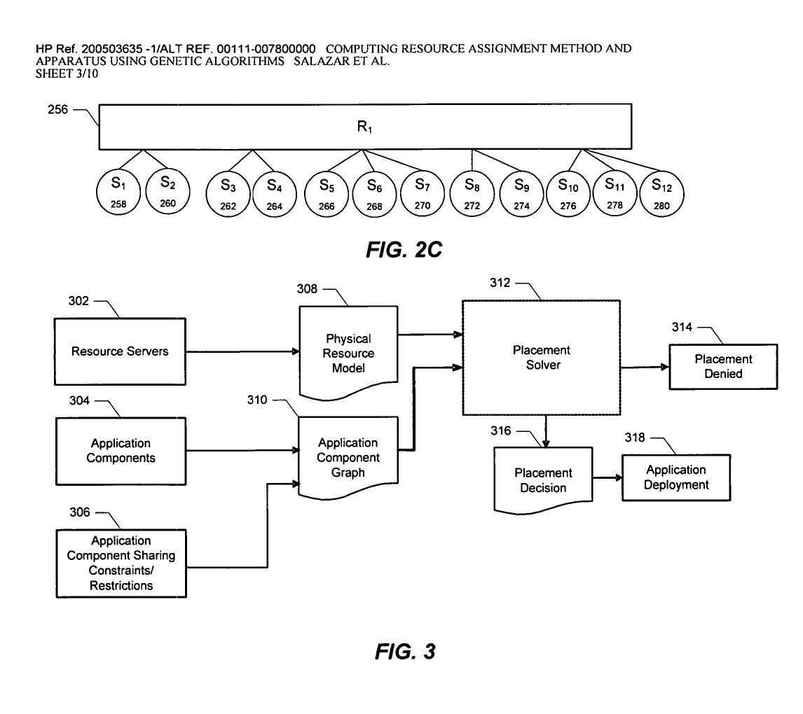

FIG. 2A is a schematic diagram of one or more application components and the communication requirements between the application components for a given application. In this example, an application component graph depicts a set of application components C₁ through C₇ identified as elements 202, 204, 206, 208, 210, 212 and 214. Each application component C₁ through C₇ represents different resource requirements in an application to be met using one or more resource servers. For example, application component C₁ can have a capacitive computing requirement specified using a processing metric or benchmark (i.e., MIPS, SPEC, GFLOP etc.) as well as a non-capacitive resource requirement relating to a type of operating system platform, processor chip compatibility (i.e., x86-compatible) or any other non-capacity oriented measurement.

The application component graph can also specify communication and transaction requirements between pairs of application components from C₁ through C₇. These specifications on the application component graph may indicate qualitative and quantitative pathway requirement between one or more application components. For example, a path between C₆ and C₄ (e.g., T₆₄ and T₄₆) may not only need to have the quality of being secure but also carry the secure data with a minimum quantitative burst or sustained transmission rate.

It is also possible that two or more application components from C₁ through C₇ may also have resource sharing constraints requiring that certain resource servers are shared. For example, an application that renders certain images may be required to share a library and graphics hardware with other portions of the application that use satellite imaging to navigate through various maps, call up various libraries and render the images in real-time. Alternatively, another pair of application components from C₁ through C₇ may have certain other resource sharing restrictions that disallow sharing of resources between the application components or simply require that no sharing of resources is possible with a particular application component. This may arise if the application component needs exclusive access to a dataset for updating the data or requires sufficient processing power that no other application component can also use the resource at the same time interval.

FIG. 2B depicts an exemplary physical network of resource servers communicating in a hierarchical manner. Each element in the physical network of FIG. 2B has a particular operational quality and capacity that contributes to the overall aggregate of resources. In this example, root 202 corresponds to a logical entry point to the network that can pass over edge switch E₁ 204 or E₂ 206 depending on which rack switch R₁ 208, R₂ 210, R₃ 212, R₄ 214 and R₅ 216 data needs to pass. Generally, edge switches aggregate more traffic and carry sustained and burst traffic at much higher speeds than rack switches. In addition to bandwidth capacities, both edge switches and rack switches may have qualitative measures relating to security, redundancies, protocol compatibilities and other non-capacitative resource measurements. In the context of the present invention edge and rack switches are resource servers for transporting data and communication.

Servers S₁ 218 through S₁₂ 240 may represent computing resources available on discrete computers, clusters of computers or a combination of discrete, clustered and blade-style computing devices. Each of these resource servers for computing S₁ 218 through S₁₂ 240 also provides both capacitive measures of their resources and non-capacitative or qualitative measures for consideration. In the case of a computer server, the computing resource servers can be measured using a capacitative metric or benchmark (i.e., MIPS, SPEC, GFLOP etc.) as well as in a non-capacitive resource requirement relating to a type of operating system platform (i.e., Windows, Linux, Mac) or processor type (i.e., AMD, Intel, Sparc).

Additional resource servers under root 202 may also include fibre channel switches FC E₁ 242, FC E₂ 244 and FC E₃ 246 coupled to fibre channel core switches C₁ 248 and C₂ 250 and actual storage devices D₁ 252 and D₂ 254. Like the computing and conventional switching devices, the fibre channel communication and storage devices are described as resource servers having both capacitive and non-capacitive qualities. For example, a storage device D₁ 252 can be described in terms of having a certain capacity in Gigabytes/Terabytes available for storage as well as having certain protocol compatibilities with protocols such as iSCSI, SCSI, Serial-ATA and other standards.

Once the information is aggregated, the resource servers depicted in FIG. 2B are made available for assignment to the application components provided by the application component graph in FIG. 2A. Aspects of the present invention operate to optimally assign the resource servers in FIG. 2B to the requirements represented by application component graph of FIG. 2A. The separation between the physical representation of the resource servers and the application component graph allows flexibility in mapping between one or more different application components and one or more different resource servers. For example, an alternate implementation may use physical network of resource servers in FIG. 2C instead of physical network of FIG. 2B. FIG. 2C depicts a set of servers S₁ 258 through S₁₂ 280 coupled together over a rack switch R₁ 256. Like the servers in FIG. 2B, the set of servers S₁ 258 through S₁₂ 280 have both capacitative and non-capacitative qualities used to describe the overall resource servers available. Rack switch R₁ 256 also has capacitive and non-capacitive qualities yet operates over a much simpler overall communication topology than the hierarchical arrangement illustrated in FIG. 2B.

An architecture depicted in FIG. 3 is used by one implementation of the present invention to assign resource servers to the requirements of one or more application components. Inputs to this architecture include resource servers 302, application components 304 and application component sharing constraints/restrictions 306. Resource servers 302 represent both the capacitative and non-capacitative description of resources available in the physical network and topology. As previously described, these values may include bandwidth capacities and protocols available on switching devices, storage capacities and protocols associated with storage devices and processing capacity metrics and chip-compatibilities for certain computing devices.

Resource servers 302 are converted into a physical resource model 308 that most aptly and succinctly describes the available resources and their relationship to each other in a network or hierarchy of devices and computing devices. The representation of resource servers 302 is also designed in a manner that can readily be accessed and used when assigning resources to one or more application components. For example, physical resource model 308 describes the available paths between two or more devices and the bandwidth available to send data over a communication path therebetween the devices. These values and descriptors can be stored in a database and indexed for high-speed access and calculations.

Similarly, application component graph 310 represents an application's different application component requirements and the relationship between the resources they require to operate within. Like the physical resource model 308, application component graph 310 indicates that certain application components of an application require transmitting data with other application components at certain data rates. Application component graph 310 also reflects certain application component resource sharing constraints requiring that certain resources are shared between application components of an application.

A must-share constraint between application components requires one or more resources to be shared between two or more different application components. Likewise, a must-not-share restriction requires that certain application components must never share their resources. Yet another constraint may specify a certain resource as unshareable when the associated application component requires exclusive use and access to the resource. For example, this last constraint may be specified to ensure that only one application component has access to a certain computing device or cluster of machines for supercomputing-type operations or calculations.

Physical resource model 308 and application component graph 310 are provided to placement solver 312 to either identify an assignment of resources in placement decision 316 or indicate a placement denied 314 if the requirements from application component graph 310 cannot be met. A subsequent application deployment 318 is made when the resource servers are determined as adequately meeting the application components requirements specified. To discover these results, placement solver 312 uses genetic algorithms designed in accordance with the present invention and as described in further detail herein below.

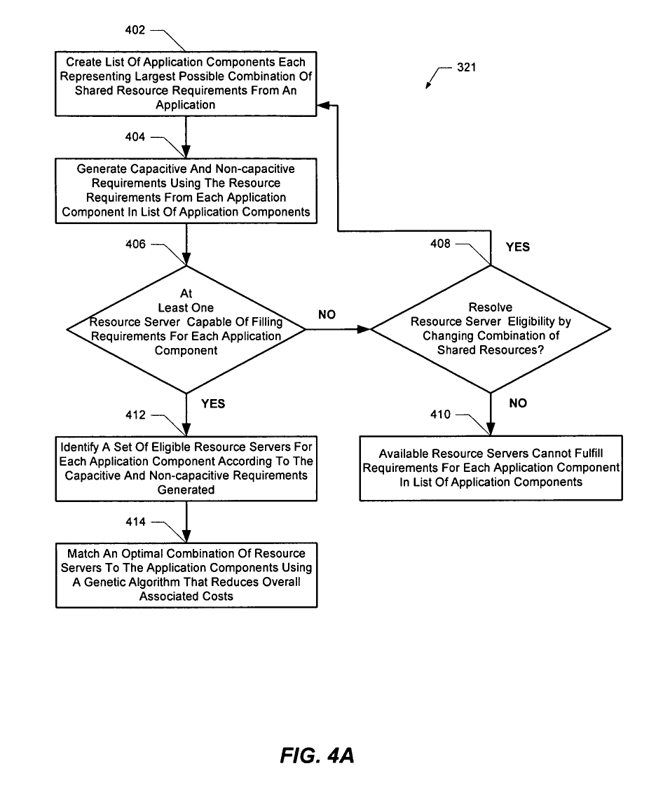

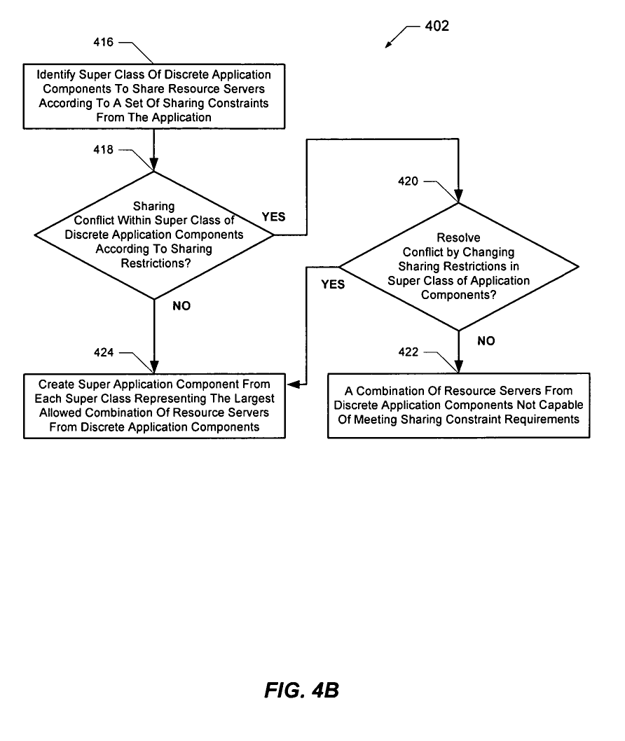

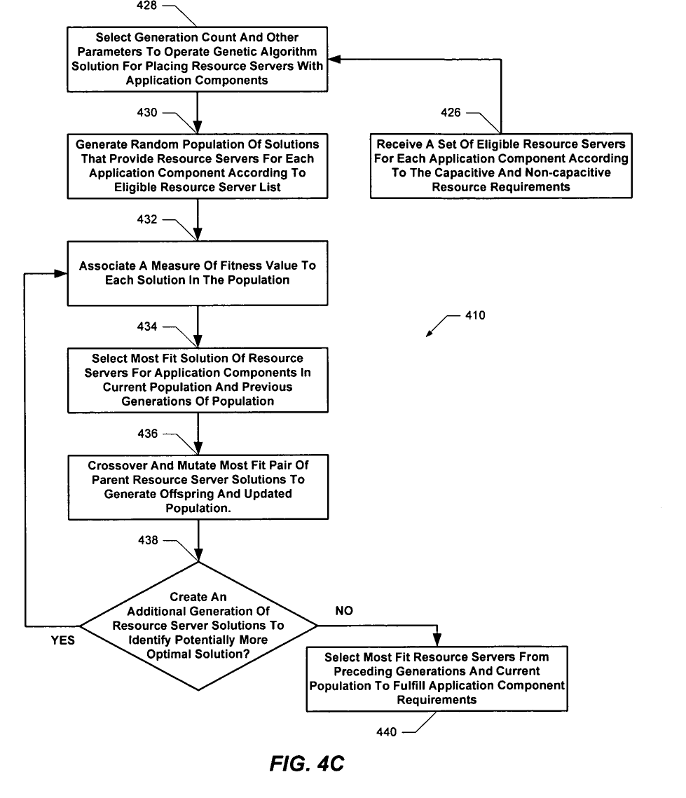

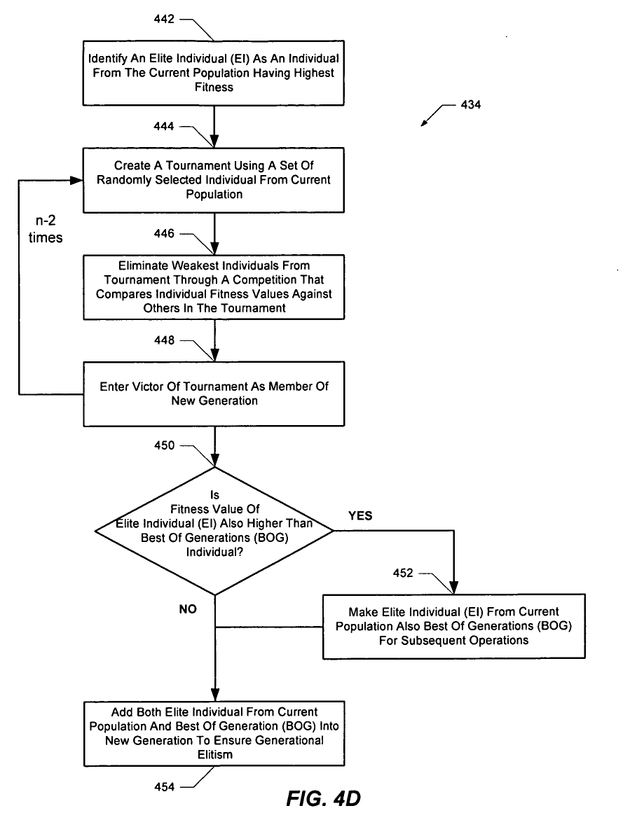

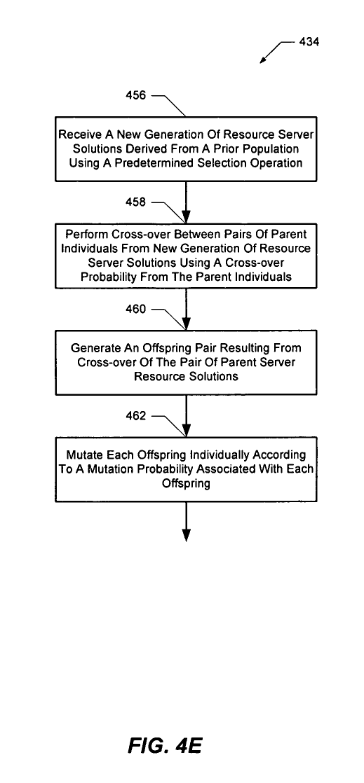

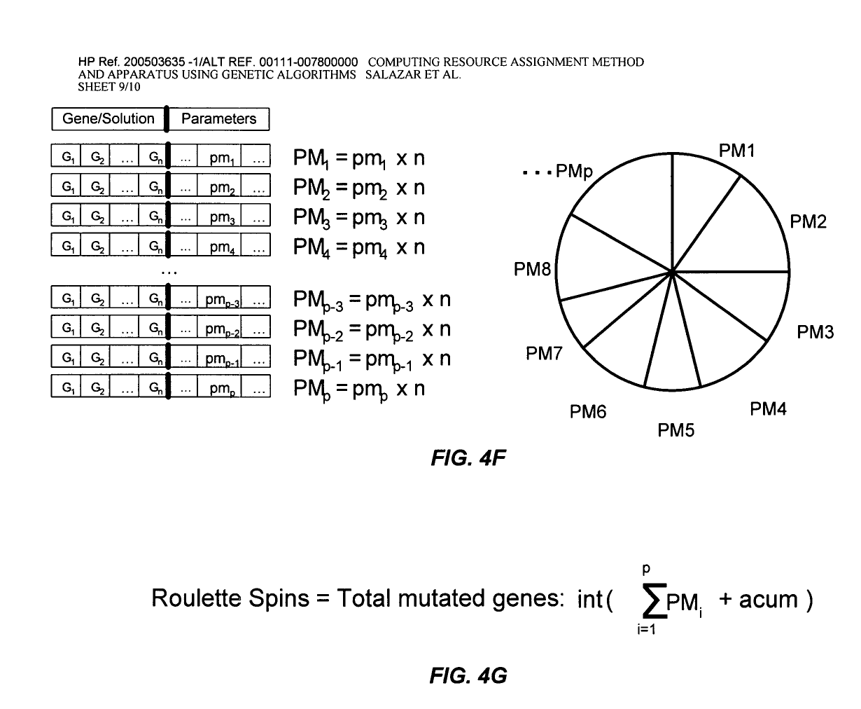

FIG. 4A provides a flowchart of the operations for assigning resource servers to one or more application components in accordance with one implementation of the present invention. Initially, the solver creates a list of application components each representing a largest possible combination of shared resource requirements from an application (402). In one implementation, a super-application component creation operation merges the application components having must-share constraints into super-application components. For purposes of fulfilling resource requirements, the super-application component is treated just like a discrete application component except for certain resource sharing requirements. One difference occurs when the super-application component is made up of two or more application components having conflicting must-not share restrictions of resources. More on the treatment of resources and must-share and must-not share constraints are described in further detail below.

Next, the solver generates capacitive and non-capacitive requirements using the resource requirements from each application component in the list of application components (404). These aggregate requirements are used to match the application components with one or more resource servers needed to fulfill the application components operational needs. Combining certain resource requirements may require the solver to compromise certain specifications between application components without violating resource requirements. For example, one application component may require a Windows operating system and x86 compatible chip architecture while another application component may not specify a particular operating system and processor type. In this case, the solver would aggregate the two application components and requirements indicating that a Windows operating system and x86 architecture is required for the resulting super-application component.

Using the largest application components, a determination is made as whether at least one resource server in the physical network can fulfill the requirements of each resulting application component (406). In many cases, a super-application component derived application component may require an aggregate amount of storage capacity and processing capacity that only one resource server can provide. This may be true even though the discrete application components making up the super-application component could otherwise have been serviced individually by many different resource server combinations.

In some cases, not even one resource server in the given physical network can provide the resources required by an application component. An attempt is then made to resolve the resource server ineligibility by changing a combination of the required shared resources (408). If the resources required by the application components can be divided without violating specified resource requirements then it may be possible to attempt to fulfill the application component requirements (402) through one or more iterations. Of course, if the required shared resources cannot feasibly be so devised then there is an indication that the available resource servers cannot fulfill requirements for each application component in list of application components (410).

Alternatively, the solver identifies a set of at least one or more eligible resource servers for each application component according to the capacitive and non-capacitive requirements generated (412). In many physical designs, there are often several different resource servers that could potentially deliver the resources required by an application component. Selecting the proper resource server to meet the requirements of an application component is complicated when one resource server can potentially fulfill the requirements for several different application components. In particular, this can be a problem if an attempt to use one particular resource server for one application component renders the solver unable to fulfill the requirements from another application component in the overall solution.

To solve this dilemma, a solver designed in accordance with the present invention matches an optimal combination of resource servers to the application components using a GA that reduces overall associated costs (414). Many different possible combinations of resource servers and application components must be tried before a solution is found. The GA randomly and rapidly generates a set of resource server solutions to this problem in a population and successively evaluates the solution with the lowest overall cost requirement. For example, costs can be measured in terms of dollars paid for computing resources as well as time to complete a given task or operation. As will be described later herein, a fitness function assigned to the particular genetic algorithm is designed to quickly identify these costs and converge upon the most optimal solution.

FIG. 4B is a flowchart diagram of the operations associated with creating a super-application component from individual discrete application components and requirements from an application in accordance with one implementation of the present invention. As a preliminary matter, the solver identifies a super-class of discrete application components to share resources according to a set of sharing constraints from the one or more application components (416). A requirement to share common resources is generally the impetus behind merging one application component of requirements with another application component of requirements.

For example, merging discrete application component C₁ with discrete application component C₂ requires evaluating and combining their individual requirements. Consider that application component C₁ requires a Linux operating system, an IA-32 processor-type and exclusive use of at least 128M of memory while C₂ does not specify an operating system but does specify an IA-32 processor-type and exclusive use of at least 64M of memory. In this case, the non-capacitive requirement to have a Linux operating system becomes the operating system required in the merged super-application component SC_{A} as only one discrete application component specified the requirement and the other inherently could use any operating system. Similarly, the IA-32 processor-type is used as it was required by both application components C₁ and C₂. Lastly, the capacitive requirement for 128M of memory in application component C₁ and 64M of memory in C₂ results in an additive requirement for a total of 192M of memory in the merged super-application component SC_{A}.

Before merging application components, the solver validates or ensures the sharing of resource servers does not result in a conflict within the super-class of discrete application components (418). As a first pass, the solver may identify direct conflicts between two or more application components. For example, a requirement for an IA-32 processor in one application component directly conflicts with an x86 Intel-compatible processor made by another application component placed in a super-class of requirements.

Subsequent passes and other comparisons between resource requirements from several application components may indicate compatibility between two application components but incompatibility between several (i.e., greater than two) application components on a transitive basis. For example, a requirement to share memory may exist between three application components but one application component may also have a ‘must-not share’ restriction due to its need to exclusively access a database. Consequently, a violation may occur if the first or second application component needs access to the database in violation of the exclusive access requirement of the third application component. Many other situations resulting in conflicts in a super-class of resources are also possible but these are a few examples.

Consequently, if the solver detects one or more conflicts then an attempt is made to resolve the conflict by changing sharing restrictions in the super-class of application component requirements (420). For example, conflicts may be resolved through a more complex analysis of the resource requirements and the flexibility of changing these requirements with respect to the discrete application component requirements. Of course, if there is no resolution of the conflict then the solver indicates that the combination of resource servers from discrete application components is not capable of meeting the sharing constraint requirements (422).

Alternatively, if the conflict is resolved or no conflict detected then the solver creates the super-application component from each super-class of application components (424). This combination of application components then represents the largest allowed combination of resource servers from discrete application components. Having the larger combination of resource servers in the super-application component facilitates a more efficient utilization of resources as fewer resources may be required in both processing and communication. For example, it is possible for two combined application components with shared memory or storage to share information more rapidly if they are being serviced using a single resource server then would be possible using multiple resource servers on a network. In one example, application components would be able to communicate directly and rapidly on a single computer or cluster of computers with message passing or shared memory instead of sending data and results back and forth over a complex arrangement of switches, routers and devices making up the network between distant computers.

FIG. 4C is a flowchart of operations for a genetic algorithm designed in accordance with one implementation of the present invention to select an optimal assignment of resources to the application components and their requirements. As previously described, the solver initially identifies a set of resource servers eligible or capable of fulfilling each application components requirement for resources (426). To make a solution feasible there must be at least one resource servers to provide the required resources for each application component however often there are multiple possibilities. It is therefore the role of the genetic algorithm designed in accordance with implementations of the present invention to select an optimal assignment of resource servers to the application components that yields both a feasible and cost-effective solution.

Equation 1 below illustrates a schematic relationship of application components with requirements and the potential feasible solutions discovered by the solver through the analysis as described above. In this example set of equations below it can be seen that certain application components have greater or fewer possible resource servers to provide feasible solutions. Each list of resource servers is an eligible resource server list specific to the application component. It can be seen that different combination of resources can be used to operate as feasible solutions for different application components.

While the exact requirements are not provided herein, it is observed that application component C₁ and application component C₆ both have five potential different resource servers to fulfill their requirements. It can also be observed that application component C₁ and application component C₆ both share resource servers R₃, R₈ as possible solutions. Accordingly, it may not be possible to solve the requirements for each application component without considering the timing and sharing of resource server solutions discovered.

$$\begin{matrix}{C}_{1} \to [ {R}_{1} , {R}_{3} , {R}_{4} , {R}_{7} , {R}_{8} ] \\ {C}_{2} \to [ {R}_{2} , {R}_{3} , {R}_{4} ] \\ {C}_{3} \to [ {R}_{1} , {R}_{7} , {R}_{8} ] \\ {C}_{4} \to [ {R}_{2} , {R}_{5} ] \\ {C}_{5} \to [ {R}_{1} , {R}_{2} , {R}_{6} , {R}_{8} ] \\ {C}_{6} \to [ {R}_{2} , {R}_{3} , {R}_{5} , {R}_{6} , {R}_{8} ]\end{matrix} \qquad Equation 1$$

An important part of the genetic algorithm includes selecting and providing the solver with a generation count and other parameters to operate the genetic algorithm solution when placing resource servers with application components (428). The generation count indicates how many different generations of solutions need be created before a solution is converged upon and found. For example, if the generation count is too few then the solutions discovered may in fact be mediocre rather than optimal as the solutions did not have sufficient time to ‘evolve’. Further, the solution may identify local minima or maxima rather than an optimal overall solution when the iteration count is set too low. It is also important to identify other genetic algorithm parameters that relate to probability of cross-over and mutation when creating offspring from parents.

Using these parameters, the solver generates a random population of solutions that provide resource servers for each application component according to eligible server list described above (430). In conjunction with a random number generator, the solver attempts to create a population size as specified in the parameters capable of solving the resource requirements demanded by the one or more different application components. There is generally no requirement that these randomly generated solutions in the initial and subsequent populations are optimal or for that matter efficient. Instead, it is assumed that sufficient iterations and evaluations of the different possible solutions using GA will result in finding the optimal or even a near-optimal solution over time.

Accordingly, the solver associates a measure of fitness value to each solution in the population that reflects the cost of using the particular assignment of resource servers to the application components (432). As previously described, the “cost” of using a resource may be monetary but is not limited to money and may include other factors tangible, intangible and non-monetary in nature. For example, a measure of fitness may rate a particular solution depending on whether the suggested solution requires a violation of certain sharing requirements or otherwise reduces the overall efficiency of the solution. Below is an example of randomly generated ‘genes’ in an initial population of solutions for the genetic algorithm. A random number generator (RNG) is used to select different combinations of feasible solutions for a given sequence of application components C₁ through C₆ but does not guarantee that any one solution is optimal or desirable by any measure.

$$\begin{matrix}{C}_{1} & {C}_{2} & {C}_{3} & {C}_{4} & {C}_{5} & {C}_{6} \\ ↓ & ↓ & ↓ & ↓ & ↓ & ↓ \\ {R}_{3} & {R}_{4} & {R}_{1} & {R}_{5} & {R}_{8} & {R}_{6}\end{matrix} \qquad Equation 2$$

The evaluation of each gene as a possible solution is based upon a valuation or cost as determined using a fitness function. The solver therefore associates a measure of fitness value to each solution in the population based upon a fitness function (434). In general, a fitness function is designed to solve a particular problem in mind and in the present case it relates to providing a measure of fitness for assigning certain resource servers to application components representing an application requirement. In one implementation of the present invention the fitness function for making this cost determination is provided below in Equation 3.
J=C×((E+S+U)×K+1) Equation 3
Where:
J is a fitness value for solution
C is a total utilization cost
E is Total Capacity Excess
S is Share error
U is Unsharable error
K is a weighting constant selected to penalize occurance of E, S, U factors (e.g., K may be set to 1000)

In this example, fitness value (J) represent the actual fitness value assigned to a solution and is used to compare the solution with other solutions in the population. In particular, a higher value indicates the resources are more costly or inefficient thus a less desirable solution or fit than a solution having a lower overall cost.

Total utilization cost (C) is a measure of cost associated with the one or more resource servers being used by the particular solution. Each resource server used in a solution may have a different cost depending on the type of resource server and the resource server's particular capabilities. In general, more resource servers will result in a larger C value. Alternatively, it is also possible to use the C value to reflect the amount of shared network capacity consumed by the application deployed using the given solution. This shared network capacity cost depends on where each application component is placed in the network and the cost of the network path for each communication flow. Using the C value in this manner results in selecting a solution that reduces the total utilization cost such that more server resources can be made available to other applications. The total utilization cost (C) is emphasized in this fitness function as a rise in this value causes a rapid rise in the final result as it is multiplied by the sum of several other factors used in the calculation.

Total capacity excess (E) is also a factor in the fitness function and represents an excess of capacity in the solution relative to the resource requirements from the application components. Excess capacity on a server is the difference between the total amount of capacity required by all the application components placed on the server and the actual available capacity from that resource server. Similarly, excess capacity for a network link is the difference between the total amount of bandwidth capacity required by all the traffic flowing through the link and the actual available bandwidth capacity on that link. In other words, capacity excess for any resource indicates the lack of certain resources and the infeasibility of the corresponding solution. Accordingly, an excess capacity in the solution is not desirable and the fitness function is increased in proportion to this value.

Share error (S) indicates that a requirement for sharing resources cannot be performed as required by the application components. Those solutions having more server resource sharing problems or conflicts will be given a higher share error value and thus a higher fitness function value. If some sharing errors are tolerable in a solution, the solution with fewer share errors will be more desirable than solutions with greater share errors. Akin to the share error, the unshareable error occurs when a requirement to not share a server resource is made by one or more application components but cannot be kept in the particular solution. For example, this may occur when there are limited resources and a particular server resource identified by an application component as unshareable must be shared to complete the proposed solution. K is merely a weighting factor selected to provide a fitness value in the range of values desired for the particular GA solution. In one implementation for example, the K weighting factor is selected to be 1000.

In one implementation, the solver selects the most fit solution of resource servers for the application components given the current population and previous generations of the population. (434). One implementation, uses a tournament selection operation to reach a solution as described in further detail later herein.

The parent solutions are used in a crossover and mutation operation to generate offspring and potentially replace the parent solutions (436). Generally, each parent in a pair is split according to a crossover point parameter and a crossover probability or frequency. Two resulting offspring are then mutated according to a mutation probability associated with each gene of the offspring.

If the parameters indicate evaluating multiple generations, then the solver creates an additional generation of resource server solutions to evaluate for a potentially better solution (438). Each additional generation creates another population that can be evaluated and used for finding an optimal solution to the assignment of resource servers. Of course, the GA may have an increased execution time of the GA as a trade-off for having many generations of solutions/populations rather than a single or fewer populations.

Once the specified number of generations have been generated and evaluated, the solution is selected. For example, the solution selected may include taking the most fit resource server solution from both the current population and all the preceding generations of resource server solutions to fulfill the application component requirements for resources (440).

FIG. 4D is a flowchart of the operations for tournament selection of resource server solutions from a population in accordance with one implementation of the present invention. Tournament selection is an efficient method of selecting individual solutions from a population for evaluation. Initially, the tournament selection identifies an elite individual (EI) as an individual from the current population having the highest fitness. For example, the EI would be the best solution of resource servers to meet the application component requirements in the given current population of solutions. It is important to keep track of the EI and make sure the EI is not inadvertently or randomly left out of the process by the random number generator.

Next, the tournament selection creates a tournament using a set of randomly selected individual from current population (444). The tournament may be as few as two competitors or many more competitors depending on the particular GA solution. One implementation uses a tournament of only two competitors however this can be set as one of the overall GA parameters. It is also possible that the EI is also randomly selected as one competitor in the tournament but this is not expected or required.

Once the tournament is filled, the tournament selection operation eliminates the weakest individuals from tournament through a competition that compares individual fitness values against others in the tournament (446). If the EI is in the tournament as previously mentioned then the EI will be the winner and all others will be eliminated from the population as the weaker individuals. The victor of the tournament is entered as a member of the new generation (448) and the process repeats n-2 times to fill the new generation with n-2 new individuals. Essentially, this process eliminates the weakest solutions in the population according to the fitness function and leaves only the better or best solutions. It is possible that a solution may be repeated multiple times in the new generation as long as there are a total of n-2 solutions. For example, an RNG may select the same individuals from the population who succeed in winning a multiple number of the n-2 tournaments held. As indicated below, two additional solutions (i.e., the elite individual (EI) and best of generations (BOG)) are always added to the new generation to ensure a total of n possible solutions in every generation; this is the reason for holding only n-2 tournaments to create the new generation.

Next, a determination is made whether a fitness value of the Elite individual (EI) is also higher than a best of generations (BOG) individual or solution (450). Tournament selection of the present invention keeps track of a best solution for a current population as the elite individual or EI as well as a solution reflecting the best of all generations over time or BOG. Inclusion of both the EI and BOG ensure the best solutions are preserved from generation to generation and the optimal or near optimal solution overall is found. In the event the EI has a higher fitness than the BOG then the elite individual (EI) from current population is made the best of generations (BOG) for subsequent operations (452). In any event, the new generation includes the winners of the tournaments as well as both the EI and the BOG to ensure generational elitism (454). Adding the EI and BOG ensures that the best solution from both the current population and all previous generations are not lost and considered in all subsequent analysis.

FIG. 4E is a flowchart of the operation used to cross-over and mutate offspring in accordance with one implementation of the present invention. The cross-over begins with a new generation of resource server solutions derived from prior population using a predetermined selection operation (456). As previously described, the tournament selection operation can be used for the selection process as well as any other selection process for the population. The selection process helps preselect the stronger individuals in a given population and eliminate weaker solutions.

Next, the cross-over operation performs a cross-over between pairs of parent individuals from the new generation of server solutions using a cross-over probability associated with the parent individuals (458). In one implementation, each parent has a cross-over probability parameter as well as a cut-point location on the parents to perform the cross-over operation. If there are two-cross over probabilities from each parent, then one is randomly selected or they are combined using an average or some other statistical representation.

The result is to generate a pair of offspring from the cross-over of the pair of parent server resource solutions (460). When the cross-over probability is very low, there is a chance that there will be no cross-over and the parents and offspring are the same solutions. Parameters for cross-over, mutation, cut-point location and other parameters for the offspring are also generally derived from the parameters of the parent solutions.

A mutation probability derived from each of the parents is used to mutate each offspring (462). In one implementation of the present invention the mutation probability may be different for each solution but is applied to each gene in the solution as a probability that each gene may be mutated or changed by a predetermined amount. Of course, if the mutated offspring are more fit than the parents, they replace the parents in the population and if they are less fit than they are discarded.

FIG. 4F depicts a schematic of increasing the efficiency associated with potentially mutating each gene given a number of resource server solutions in accordance with one implementation of the present invention. This approach identifies all the possible resource server solutions in a population and then uses a roulette wheel to identify the resource server solution to receive a mutation. Accordingly, an expected probability of mutating each gene of a solution is identified as PMₚ given p possible solutions. Since each gene has the same likelihood of mutating, the sum of the probabilities of each gene mutating is the probability of mutation pmₚ times n or the length of the gene.

A roulette wheel is constructed mathematically such that the area occupied on the wheel is proportional to the expected probability of genetic mutation in the solution ranging from PM₁ to PMₚ. A solution occupying more area or a longer distance along the circumference of the roulette wheel is more likely to experience mutation than not. Each time the wheel is “spun” at least one solution is mutated. For example, a RNG that generates a value between 0 and 1 can be used to select that section of the roulette wheel and gene/solution to receive the mutation.

FIG. 4G provides one calculation for determining the number of spins of the roulette while in accordance with one implementation of the present invention. In this example, the sum of the probabilities of mutation for each solution PMi plus an accumulation of fractional values determines the number of “spins” to perform. The value of “accum” represents a sum of these fractional values collected throughout the summation of values. Spinning the roulette wheel multiple times ensures that multiple corresponding mutations will occur thus fulfilling the total number of mutated genes requirement.

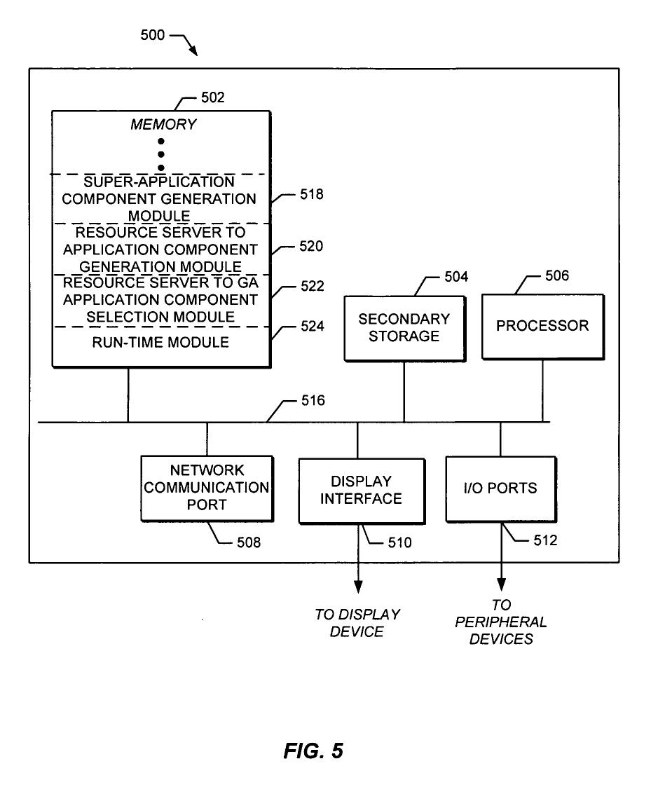

FIG. 5 is a schematic diagram of a server resource placement system 500, hereinafter system 500, and modules used in accordance with one implementation of the present invention. System 500 includes a memory 502 to hold executing programs (typically random access memory (RAM) or read-only memory (ROM) such as a flash RAM), a secondary storage 504 such as a disk drive be used for temporary storage and swap space for data, a processor 506, a network communication port 508 for data communication, a display interface 510 to render images on a display device when using the solver, input/output (I/O) ports 512 operatively coupled together over an interconnect 516.

The solver designed in accordance with various aspects of the present invention uses one or more of the aforementioned modules in memory 502 to discover and implement an acceptable assignment of resources to an application. Accordingly, system 500 can be preprogrammed, in ROM, for example, using field-programmable gate array (FPGA) technology or it can be programmed (and reprogrammed) by loading a program from another source (for example, from a floppy disk, a CD-ROM, or another computer). Also, system 500 can be implemented using customized application specific integrated circuits (ASICs).

In one implementation, memory 502 includes super-application component generation module 518 to combine discrete application components and requirements together into the largest set of application components as previously described. Further, resource server to application component generation module 520 evaluates the available resource servers and determines if any solution or multiple solutions are possible or feasible. Resource server to GA application component selection module 522 takes the potential resource server solutions to each application component requirements and using GA to identify an optimal solution under the circumstances. Run-time module 524 may be any real-time or non-real-time operating system or other executive program designed to manage the resources and operation of system 500. As mentioned previously, the final solution is preferably a near optimal solution and in some cases may also be the optimal solution. However, it is more often that a near optimal solution to the assignment of resources is adequate as it takes less time to discover and may be close to the performance characteristics of the actual optimal or even best solution.

While examples and implementations have been described, they should not serve to limit any aspect of the present invention. Accordingly, implementations of the invention can be implemented in digital electronic circuitry, or in computer hardware, firmware, software, or in combinations of them. Apparatus of the invention can be implemented in a computer program product tangibly embodied in a machine-readable storage device for execution by a programmable processor; and method steps of the invention can be performed by a programmable processor executing a program of instructions to perform functions of the invention by operating on input data and generating output. The invention can be implemented advantageously in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object-oriented programming language, or in assembly or machine language if desired; and in any case, the language can be a compiled or interpreted language. Suitable processors include, by way of example, both general and special purpose microprocessors. Generally, a processor will receive instructions and data from a read-only memory and/or a random access memory. Generally, a computer will include one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM disks. Any of the foregoing can be supplemented by, or incorporated in, ASICs.

While specific embodiments have been described herein for purposes of illustration, various modifications may be made without departing from the spirit and scope of the invention. Accordingly, the invention is not limited to the above-described implementations, but instead is defined by the appended claims in light of their full scope of equivalents.

What is claimed is:

1. A computer implemented method of assigning computing resources in a data center to meet computing resource requirements of one or more application components, comprising:
creating a list of application components wherein each application component representing a largest possible combination of shared resource requirements;
identifying a set of eligible resource servers wherein each resource server is capable of fulfilling the shared resource requirements for each application component in the list of application components; and
matching an optimal combination of resource servers to each application component in the list of application components using a genetic algorithm that selects the resource servers to reduce overall associated related costs.

2. The method of claim 1 wherein creating each application component in the list of application components further comprises,
identifying a super-class of discrete application components capable of sharing their required resources based upon a set of resource sharing constraints from each of the one or more application components;
determining if the super-class of discrete application components and associated resources should not be shared based upon a set of resource sharing restrictions; and
creating a super-application component from each super-class of application components in response to the determination that represents the largest allowed combination of shared resources from the discrete application components.

3. The method of claim 2 wherein the discrete application component includes a set of resource requirements from an application.

4. The method of claim 2 further comprising,
using the discrete application components and associated required resources when the determination indicates that the combination of resources in the super-class of discrete application components cannot be shared without violating one or more sharing restrictions from the one or more applications.

5. The method of claim 2 wherein creating a super-application component from each super-class of application components further comprises:
resolving conflict between a set of resource sharing constraints and a set of resource sharing restrictions by modifying the resource sharing constraints and the resource sharing restrictions.

6. The method of claim 1 wherein the matching using a genetic algorithm further comprises:
generating a random population of resource server solutions over one or more generations of populations that each provides a set of resource servers capable of fulfilling the resource requirements for each application component in the list of application components;
associating a measure of fitness to each resource server solution in the random population that attributes a utilization cost with each resource server and a cost for exceeding capacity available from each resource server when the resource requirements from the application components assigned to the resource exceed the available capacity of the resource; and
selecting a resource server solution from the random population of resource server solutions over one or more population generations when the measure of fitness associated with the resource server solution indicates the resource server solution provides an optimal solution compared to other resource server solutions in the random population and over one or more generations.

7. The method of claim 6 wherein the measure of fitness further attributes a cost to determining that two or more application components have a share error as they assigned to the same application component and resource server despite having a sharing restriction between the application components.

8. The method of claim 6 wherein the measure of fitness further attributes a cost to determining that multiple application components are assigned to a single resource server even when there is an indication that only one of the multiple application components are allowed to be assigned to the resource server.

9. The method of claim 6 wherein the selecting a resource server solution further comprises:
selecting at least a pair of resource server solutions as parents using a tournament selection approach that randomly selects at least a pair of resource server solutions and eliminates all but the resource server solutions with the highest measure of fitness according to the fitness function;
generating offspring from the resource server solutions not eliminated to replenish the population in a subsequent generation using the parent not discarded from the selection using one or more crossover and mutation operations.

10. A computer program product, tangibly stored on a computer-readable medium, for assigning computing resources in a data center to meet computing resource requirements of one or more application components, comprising instructions operable to cause a programmable processor to:
create a list of application components wherein each application component representing a largest possible combination of shared resource requirements;
identify a set of eligible resource servers wherein each resource server is capable of fulfilling the shared resource requirements for each application component in the list of application components; and
match an optimal combination of resource servers to each application component in the list of application components using a genetic algorithm that selects the resource servers to reduce overall associated related costs.

11. The computer program product of claim 10 wherein creating each application component in the list of application components further comprises instructions that,
identify a super-class of discrete application components capable of sharing their required resources based upon a set of resource sharing constraints from each of the one or more application components;
determine if the super-class of discrete application components and associated resources should not be shared based upon a set of resource sharing restrictions; and
create a super-application component from each super-class of application components in response to the determination that represents the largest allowed combination of shared resources from the discrete application components.

12. The computer program product of claim 11 wherein the discrete application component includes a set of resource requirements from an application.

13. The computer program product of claim 11 further comprising instructions that,
use the discrete application components and associated required resources when the determination indicates that the combination of resources in the super-class of discrete application components cannot be shared without violating one or more sharing restrictions from the one or more applications.

14. The computer program product of claim 11 wherein creating a super-application component from each super-class of application components further comprises instructions that:
resolve conflict between a set of resource sharing constraints and a set of resource sharing restrictions by modifying the resource sharing constraints and the resource sharing restrictions.

15. The computer program product of claim 10 wherein the matching using a genetic algorithm further comprises instructions that:
generate a random population of resource server solutions over one or more generations of populations that each provides a set of resource servers capable of fulfilling the resource requirements for each application component in the list of application components;
associate a measure of fitness to each resource server solution in the random population that attributes a utilization cost with each resource server and a cost for exceeding capacity available from each resource server when the resource requirements from the application components assigned to the resource exceed the available capacity of the resource; and
select a resource server solution from the random population of resource server solutions over one or more population generations when the measure of fitness associated with the resource server solution indicates the resource server solution provides an optimal solution compared to other resource server solutions in the random population and over one or more generations.

16. The computer program product of claim 15 wherein the measure of fitness further attributes a cost to determining that two or more application components have a share error as they assigned to the same application component and resource server despite having a sharing restriction between the application components.

17. The computer program product of claim 15 wherein the measure of fitness further attributes a cost to determining that multiple application components are assigned to a single resource server even when there is an indication that only one of the multiple application components are allowed to be assigned to the resource server.

18. The computer program product of claim 15 wherein the selecting a resource server solution further comprises instructions that:
select at least a pair of resource server solutions as parents using a tournament selection approach that randomly selects at least a pair of resource server solutions and eliminates all but the resource server solutions with the highest measure of fitness according to the fitness function;
generate offspring from the resource server solutions not eliminated to replenish the population in a subsequent generation using the parent not discarded from the selection using one or more crossover and mutation operations.

19. An apparatus for assigning computing resources in a data center to meet computing resource requirements of one or more application components, comprising:
means for creating a list of application components wherein each application component representing a largest possible combination of shared resource requirements;
means for identifying a set of eligible resource servers wherein each resource server is capable of fulfilling the shared resource requirements for each application component in the list of application components; and
means for matching an optimal combination of resource servers to each application component in the list of application components using a genetic algorithm that selects the resource servers to reduce overall associated related costs.
